(19) United States
(12) Patent Application Publication
(10) Pub. No.: US 2018/0009950 A1
(43) Pub. Date: Jan. 11, 2018

(54) DESALINATION OF POLYARYL ETHERS FROM A MELT POLYMERIZATION METHOD

(71) Applicant: BASF SE, Ludwigshafen (DE)

(72) Inventors: Simon GRAMLICH, Hirschberg (DE); Achim STAMMER, Freinsheim (DE)

(73) Assignee: BASF SE, Ludwigshafen (DE)

(21) Appl. No.: 15/545,385

(22) PCT Filed: Jan. 22, 2016
(86) PCT No.: PCT/EP2016/051372

§ 371 Date: Jul. 21, 2017

(30) Foreign Application Priority Data
Jan. 23, 2015 (EP) 15152256.2

(51) Int. Cl. C08G 75/23; B29C 71/00; B29K 105/04; B29C 44/50; B29K 71/00

(52) U.S. Cl. CPC C08G 75/23; B29C 71/0009; B29K 2071/00; B29C 44/50; B29K 2105/04; B29C 2071/0027

(57) ABSTRACT

A method for desalinating a salt-containing polymer is provided. The salt-containing polymer contains a polyaryl ether and a salt. The method includes the steps of mechanically increasing the surface area of the salt-containing polymer to obtain a salt-containing polymer of increased surface area, and contacting the salt-containing polymer of increased surface area with an extractant to obtain a desalinated polymer containing the polyaryl ether, and a salt-containing extractant containing the extractant and the salt.

The present invention relates to a method for desalinating a salt-containing polymer (SP) comprising a polyaryl ether and a salt (S), and to the desalinated polymer (DP) which comprises the polyaryl ether and is obtainable by this method.

A group of polyaryl ethers of particular economic significance is that of the polyaryl ether sulfones. Polyaryl ether polymers are part of the group of the high-performance thermoplastics and are notable for high heat distortion resistance combined with good mechanical properties and inherent flame retardancy.

The preparation of polyaryl ether polymers has long been known. The preparation of polyaryl ether polymers is generally effected by polycondensation of corresponding aromatic dihydroxyl compounds with aromatic dihalogen compounds, the polycondensation being conducted in an aprotic polar solvent in the presence of potassium carbonate as base. The polyaryl ether polymers are obtained in the production process in the form of a solution comprising the polyaryl ether polymers dissolved in the aprotic polar solvent. The potassium halide formed during the reaction can be separated from the solution by mechanical means, for example by centrifugation or filtration, such that the solution and hence also the subsequently isolated polyaryl ether polymers comprise only a small amount of or even no potassium halide. For subsequent isolation of the polyaryl ether polymers from the aprotic polar solvent, various methods are described in the prior art.

According to the methods described in DE 1 957 091 and EP 0 000 361 for isolation of polyaryl ether polymers which are prepared by polycondensation in an aprotic polar solvent, the solution comprising the polyaryl ether polymers dissolved in an aprotic polar solvent is introduced into water and the polyaryl ether polymers are precipitated thereby.

DE 3 644 464 and EP 2 305 740 likewise describe processes for preparing polyaryl ether polymers by polycondensation in an aprotic polar solvent. The solution obtained, comprising the polyaryl ether polymers dissolved in the aprotic polar solvent, is subsequently dropletized in a precipitation bath comprising water, and the polyaryl ether polymers are thus obtained in the form of beads.

U.S. Pat. No. 4,113,698 describes a process for preparing polyether ketones by nucleophilic polycondensation of an alkali metal bisphenoxide and a dihalogen compound and/or an alkali metal halophenoxide in an aromatic sulfone solvent. The product obtained is subsequently comminuted to a particle size of <500 μm and washed out of these particles, the alkali metal halide formed in the reaction.

GB 2376019 describes the purification of polyether ketones and polyether ether ketones. For purification, the polyether ketones or polyether ether ketones are contacted with water. The polyether ketones or polyether ether ketones here are in the form of powders, pellets or granules. It is then possible to remove alkali metal halide salt polyether ketones and polyether ether ketones present in the water.

GB 2 245 577 describes a process for preparing polyaryl sulfones proceeding from dihydroxyl compounds and dihalogen compounds, preferably in the presence of a solvent. Also used is an alkali metal carbonate or hydroxide. Subsequently, the reaction mixture obtained is cooled, in the course of which it solidifies, and finally ground to particles having a maximum size of 0.5 mm. Subsequently, the alkali metal salt present in the reaction mixture is extracted with water.

EP 2 444 445 also describes a process for preparing polymers, wherein the reactants are converted in the presence of an organic solvent and an alkali metal carbonate. The polymer solution is added to water to obtain a solid polymer. The solid polymer is finally ground to a powder and boiled in water in order to remove the salt therefrom.

WO 2010/046482 describes the preparation of polyaryl ether ketones in the presence of diphenyl sulfone as solvent, and in the presence of sodium carbonate and finely ground potassium carbonate. The reaction mixture obtained is cooled, ground to a particle size of <2 mm, and then the salts present therein and diphenyl sulfone are removed with a mixture of water and acetone.

What is common to all the methods described in the prior art in which polyaryl ether polymers are prepared by polycondensation in an aprotic polar solvent is that they have only a low content of alkali metal halide. However, it is not possible to completely remove the aprotic polar solvent from the polyaryl ether polymers. These aprotic polar solvents are consequently also present in moldings which are produced from the polyaryl ether polymers obtainable by the processes described above.

The aprotic polar solvents can migrate out of these moldings in the course of use thereof. The moldings thus obtained are therefore a matter of toxicological concern. The moldings are consequently frequently unsuitable for food applications in particular.

In order to avoid any residual content of aprotic polar solvent in the polyaryl ether polymers, the prior art describes melt polymerization processes for preparing polyaryl ether polymers.

DE 2 749 645 describes a method for preparing polyaryl ethers in a melt polymerization method by polycondensation of at least one bisphenol with at least one dihalobenzene compound or of a halophenol in the presence of anhydrous alkali metal carbonate in the absence of solvents or diluents.

The reaction is conducted in a kneader or in an extruder. The inorganic constituents which are formed during the condensation reaction, for example sodium chloride or potassium chloride, are removed from the polyethers by dissolution and subsequent filtration, sieving or extraction.

WO 2014/033321 likewise describes a method for preparing aromatic polyaryl ethers in a melt polymerization method by reacting a dichlorodiphenyl sulfone component with a bisphenol component in the presence of an alkali metal carbonate in the absence of solvents or diluents, the reaction being conducted in a mixing kneader. The polyaryl ether polymers thus obtained are ground to a particle size of about 2 mm and washed twice with water at 80° C. for 3 hours in order to remove the alkali metal chloride formed as a by-product. By the method described in WO 2014/033321, it is only possible to remove 80% of the alkali metal chloride from the polyaryl ether.

The polyaryl ether polymers prepared by melt polymerization do not have any residual content of aprotic polar solvent.

However, a disadvantage in the processes described in the prior art for preparing polyaryl ether polymers by a melt polymerization method is the incomplete removal of the alkali metal chloride from the polyaryl ether polymers obtained. The polyaryl ether polymers are thus of low storage stability, since potassium chloride in particular is hygroscopic and absorbs moisture from the environment. This results in swelling of the polyaryl ether polymers. Moreover, they can be processed further only with difficulty, since the alkali metal chloride catalyzes progression of the polymerization reaction in the course of remelting. The polyaryl ether polymers obtained are thus of low melt stability. Moreover, polyaryl ether polymers are frequently used as membranes. If the residual content of potassium chloride in particular in the polyaryl ether polymers is too high, holes form in the membranes in the course of production of the membranes, which cause them to be unsuitable for use as a membrane.

CN 102786681 describes an apparatus for purification of a polymer. This preferably involves washing a solid and pulverulent particulate or ring-shaped polyarylene ether with water. It is thus an object of the present invention to provide an improved method for desalinating a salt-containing polymer (SP) comprising a polyaryl ether and a salt (S). The desalinated polymer (DP) thus prepared should have a low or zero residual content of aprotic polar solvents and a reduced residual content of salt (S) compared to the polyaryl ether polymers obtainable by the prior art methods. The method of the invention and the desalinated polymers (DP) obtainable thereby are to have the disadvantages of the methods described in the prior art and of the polymers obtainable therefrom only to a reduced degree, if at all. The method of the invention is to be simple, have a minimum susceptibility to faults and be performable inexpensively.

This object is achieved in accordance with the invention by a method for desalinating a salt-containing polymer (SP) comprising a polyaryl ether and a salt (S), comprising the steps of
a) mechanically increasing the surface area of the salt-containing polymer (SP) to obtain a salt-containing polymer of increased surface area (SPISA),
b) contacting the salt-containing polymer of increased surface area (SPISA) from method step a) with an extractant (E) to obtain a desalinated polymer (DP) comprising the polyaryl ether, and a salt-containing extractant (SE) comprising the extractant (E) and the salt (S), the surface area of the salt-containing polymer (SP) being mechanically increased in method step a) by foaming or drawing the salt-containing polymer (SP).

The present invention also relates to a method for desalinating a salt-containing polymer (SP) comprising a polyaryl ether and a salt (S), comprising the steps of
a) mechanically increasing the surface area of the salt-containing polymer (SP) to obtain a salt-containing polymer of increased surface area (SPISA),
b) contacting the salt-containing polymer of increased surface area (SPISA) from method step a) with an extractant (E) to obtain a desalinated polymer (DP) comprising the polyaryl ether, and a salt-containing extractant (SE) comprising the extractant (E) and the salt (S).

It has been found that, surprisingly, the method of the invention, compared to the methods described in the prior art, can remove more salt (S) from the salt-containing polymer (SP) within the same period of time. Moreover, the salt (S) can be removed more quickly from the salt-containing polymer (SP). Surprisingly, the method of the invention can achieve a salt content of not more than 150 ppm by weight in the desalinated polymer (DP). This distinctly increases the storage stability of the desalinated polymer (DP) compared to the polyaryl ether polymers from the prior art which are prepared by a melt polymerization process. The desalinated polymer (DP) additionally has good melt stability.

The method of the invention is also suitable for the desalination of salt-containing polymers (SP) which have been prepared by a melt polymerization process. If salt-containing polymers (SP) prepared by melt polymerization processes are used in the method of the invention, the desalinated polymers (DP) do not have any residual solvent content. Thus, the desalinated polymers (DP) thus obtainable are also usable for the production of moldings suitable for food applications.

Salt-Containing Polymer (SP)

According to the invention, the salt-containing polymer (SP) comprises a polyaryl ether and a salt (S).

According to the invention, “a polyaryl ether” is understood to mean exactly one polyaryl ether or else mixtures of two or more polyaryl ethers.

According to the invention, “a salt (S)” is understood to mean exactly one salt (S) or else mixtures of two or more salts (S).

In one embodiment, the salt-containing polymer (SP) comprises at least 50% by weight, particularly preferably at least 60% by weight, more preferably at least 65% by weight and especially preferably at least 70% by weight of the polyaryl ether, based in each case on the total weight of the salt-containing polymer (SP).

In a further embodiment, the salt-containing polymer (SP) comprises at most 99.98% by weight, preferably at most 99% by weight, more preferably at most 90% by weight and especially preferably at most 80% by weight of the polyaryl ether, based in each case on the total weight of the salt-containing polymer (SP).

Preferably, the salt-containing polymer (SP) comprises 50% to 99.98% by weight, more preferably 60% to 99% by weight, especially preferably 65% to 90% by weight and most preferably 70% to 80% by weight of the polyaryl ether, based in each case on the total weight of the salt-containing polymer (SP).

In one embodiment, the salt-containing polymer (SP) comprises at least 0.02% by weight, preferably at least 1% by weight, more preferably at least 10% by weight and especially preferably at least 20% by weight of the salt (S), based in each case on the total weight of the salt-containing polymer (SP).

In a further embodiment, the salt-containing polymer (SP) comprises at most 50% by weight, preferably at most 40% by weight, more preferably at most 35% by weight and especially preferably at most 30% by weight of the salt (S), based in each case on the total weight of the salt-containing polymer (SP).

It is also preferable that the salt-containing polymer (SP) comprises 0.02% to 50% by weight of the salt (S), more preferably 1% to 40% by weight of the salt (S), especially preferably 10% to 35% by weight and most preferably 20% to 30% by weight of the salt (S), based in each case on the total weight of the salt-containing polymer (SP).

It is possible that the salt-containing polymer (SP) additionally comprises additives.

Suitable additives are known as such to those skilled in the art. If the salt-containing polymer (SP) additionally comprises additives, the salt-containing polymer (SP) generally comprises 0.01% to 10% by weight of additives, preferably 0.01% to 7% by weight of additives and especially preferably 0.01% to 5% by weight of additives, based in each case on the total weight of the salt-containing polymer (SP). In one embodiment, the salt-containing polymer (SP) does not comprise any additional additives.

In addition, the salt-containing polymer (SP) may comprise a carbonate compound (C). With regard to the carbonate compound (C), the details and preferences described further down apply. If the salt-containing polymer (SP) comprises a carbonate compound (C), the salt-containing polymer (SP) comprises in the range from 0.01% to 20% by weight, preferably in the range from 0.01% to 5% by weight and especially preferably in the range from 0.01% to 2% by weight of the carbonate compound (C), based on the total weight of the salt-containing polymer (SP). The carbonate compound (C) is different than the salt (S). In one embodiment, the salt-containing polymer (SP) does not comprise any carbonate compound (C).

“A carbonate compound (C)” in the context of the present invention means either exactly one carbonate compound (C) or a mixture of two or more carbonate compounds (C).

In a further embodiment, the salt-containing polymer (SP) comprises 50% to 99.98% by weight of the polyaryl ether and 0.02% to 50% by weight of the salt (S), preferably 60% to 99% by weight of the polyaryl ether and 1% to 40% by weight of the salt (S), especially preferably 65% to 90% by weight of the polyaryl ether and 10% to 35% by weight of the salt (S) and most preferably 70% to 80% by weight of the polyaryl ether and 20% to 30% by weight of the salt (S), based in each case on the total weight of the salt-containing polymer (SP). In general, the sum totals of the percentages by weight of the polyaryl ether, the salt (S) and any additional additives and the carbonate compound (C) add up to 100%.

The viscosity numbers of the salt-containing polymer (SP) are generally in the range from 30 to 120 mL/g, preferably from 35 to 110 mL/g and especially preferably from 40 to 100 mL/g, determined by Ubbelohde viscosity number measurement of a 0.01 g/mL solution of the salt-containing polymer (SP) in a 1:1 phenol/1,2-dichlorobenzene mixture in accordance with DIN 51562.

In general, the salt (S) comprises a cation and a halide, preferably a cation and a chloride. A halide is also referred to as a halide anion. A chloride is also referred to as a chloride anion.

According to the invention, “a cation” is understood to mean exactly one cation or else mixtures of two or more cations.

According to the invention, “a halide” is understood to mean exactly one halide or else mixtures of two or more halides.

The percentages by weight of the salt (S) in the salt-containing polymer (SP) can therefore be determined via the measurement of the percentages by weight of the halide, preferably of the chloride, in the salt-containing polymer (SP). The percentages by weight of the halide are understood to mean the percentages by weight of the anionic halogen, i.e. the percentages by weight of the free halide and not the percentages by weight of the polymer-bound halogen. The same applies to the percentages by weight of chloride. These relate to the percentages by weight of the ionic chlorine and hence to the percentages by weight of the free chloride and not to the percentages by weight of the polymer-bound chlorine.

To determine the percentages by weight of halide, preferably of chloride, in the salt-containing polymer (SP), 700 mg of the salt-containing polymer (SP) are dissolved in N-methylpyrrolidone (NMP) and the resulting solution is diluted with an acetic acid/acetone mixture (ratio of acetic acid to acetone 1:1). The solution thus obtained is acidified with sulfuric acid or nitric acid and then potentiometrically titrated with a 0.0002 mol/L silver nitrate solution, using methyl orange as indicator. The electrode used is an Ag Titrode from Metrohm.

The percentages by weight of halide can subsequently be used to calculate the percentages by weight of the cation likewise present in the salt (S) in the salt-containing polymer (SP). Methods for this purpose are known to those skilled in the art. The sum total of the percentages by weight of the halide and of the percentages by weight of the cation in the salt-containing polymer then gives the percentages by weight of the salt (S) in the salt-containing polymer (SP).

The percentages by weight of salt (S) in the pre-desalinated polymer (PDP) described hereinafter and the desalinated polymer (DP) are determined in the same manner in accordance with the invention.

Polyaryl ethers are known to those skilled in the art as a polymer class. Useful polyaryl ethers for use in the method of the invention are in principle any which are known to those skilled in the art and/or preparable by known methods. Corresponding methods for preparation are elucidated further down.

Preferred polyaryl ethers are formed from units of the general formula (I):

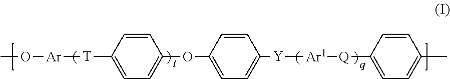

where the symbols t, q, Q, T, Y, Ar and Ar¹ are defined as follows:
t, q: each independently 0, 1, 2 or 3,
Q, T, Y: each independently a chemical bond or group selected from —O—, —S—, —SO₂—, S═O, C═O, —N═N— and —CR^{a}R^{b} where R^{a} and R^{b} are each independently a hydrogen atom or a C₁-C₁₂-alkyl, C₁-C₁₂-alkoxy or C₆-C₁₈-aryl group, and where at least one of Q, T and Y is —SO₂—, and
Ar, Ar¹: each independently an arylene group having from 6 to 18 carbon atoms.

If Q, T or Y, among the abovementioned conditions, is a chemical bond, this is understood to mean that the adjacent group to the left and the adjacent group to the right are bonded directly to one another via a chemical bond.

Preferably, however, Q, T and Y in formula (I) are each independently selected from —O— and —SO₂—, with the proviso that at least one of the group consisting of Q, T and Y is —SO₂—. These polyaryl ethers are polyaryl ether sulfones.

The present invention thus also provides a method in which the polyaryl ether is a polyaryl ether sulfone.

If Q, T or Y is —CR^{a}R^{b}—, R^{a} and R^{b} are each independently a hydrogen atom or a C₁-C₂-alkyl, C₁-C₁₂-alkoxy or C₆-C₁₈-aryl group.

Preferred C₁-C₁₂-alkyl groups comprise linear and branched, saturated alkyl groups having from 1 to 12 carbon atoms. Particular mention should be made of the following radicals: C₁-C₆-alkyl radical such as methyl, ethyl, n-propyl, i-propyl, n-butyl, sec-butyl, 2- or 3-methylpentyl and longer-chain radicals such as unbranched heptyl, octyl, nonyl, decyl, undecyl, lauryl and the singly or multiply branched analogs thereof.

Useful alkyl radicals in the aforementioned usable C₁-C₁₂-alkoxy groups include the alkyl groups defined further up having from 1 to 12 carbon atoms. Cycloalkyl radicals usable with preference include especially C₃-C₁₂cycloalkyl radicals, for example cyclopropyl, cydobutyl, cyclopentyl, cyclohexyl, cydoheptyl, cyclooctyl, cyclopropylmethyl, cyclopropylethyl, cyclopropylpropyl, cydobutylmethyl, cydobutylethyl, cydopentylethyl, -propyl, -butyl, -pentyl, -hexyl, cyclohexylmethyl, -dimethyl, and -trimethyl.

Ar and Ar¹ are each independently a C₆-C₁₆-arylene group. Proceeding from the starting materials described below, Ar is preferably derived from an electron-rich aromatic substance subject to easy electrophilic attack, preferably selected from the group consisting of hydroquinone, resorcinol, dihydroxynaphthalene, especially 2,7-dihydroxynaphthalene, and 4,4′-bisphenol. Ar¹ is preferably an unsubstituted C₆— or C₁₂arylene group.

Useful C₆-C₁₆-arylene groups Ar and Ar¹ include in particular phenylene groups such as 1,2-, 1,3- and 1,4-phenylene, naphthylene groups, for example 1,6-, 1,7-, 2,6- and 2,7-naphthylene, and the arylene groups derived from anthacene, phenanthrene and naphthacene.

Preferably, Ar and Ar¹ in the preferred embodiment of formula (I) are each independently selected from the group consisting of 1,4-phenylene, 1,3-phenylene, naphthylene, especially 2,7-dihydroxynaphthylene, and 4,4′-bisphenylene.

Preferred polyaryl ethers are those comprising at least one of the following units Ia to Io as repeat structural units:

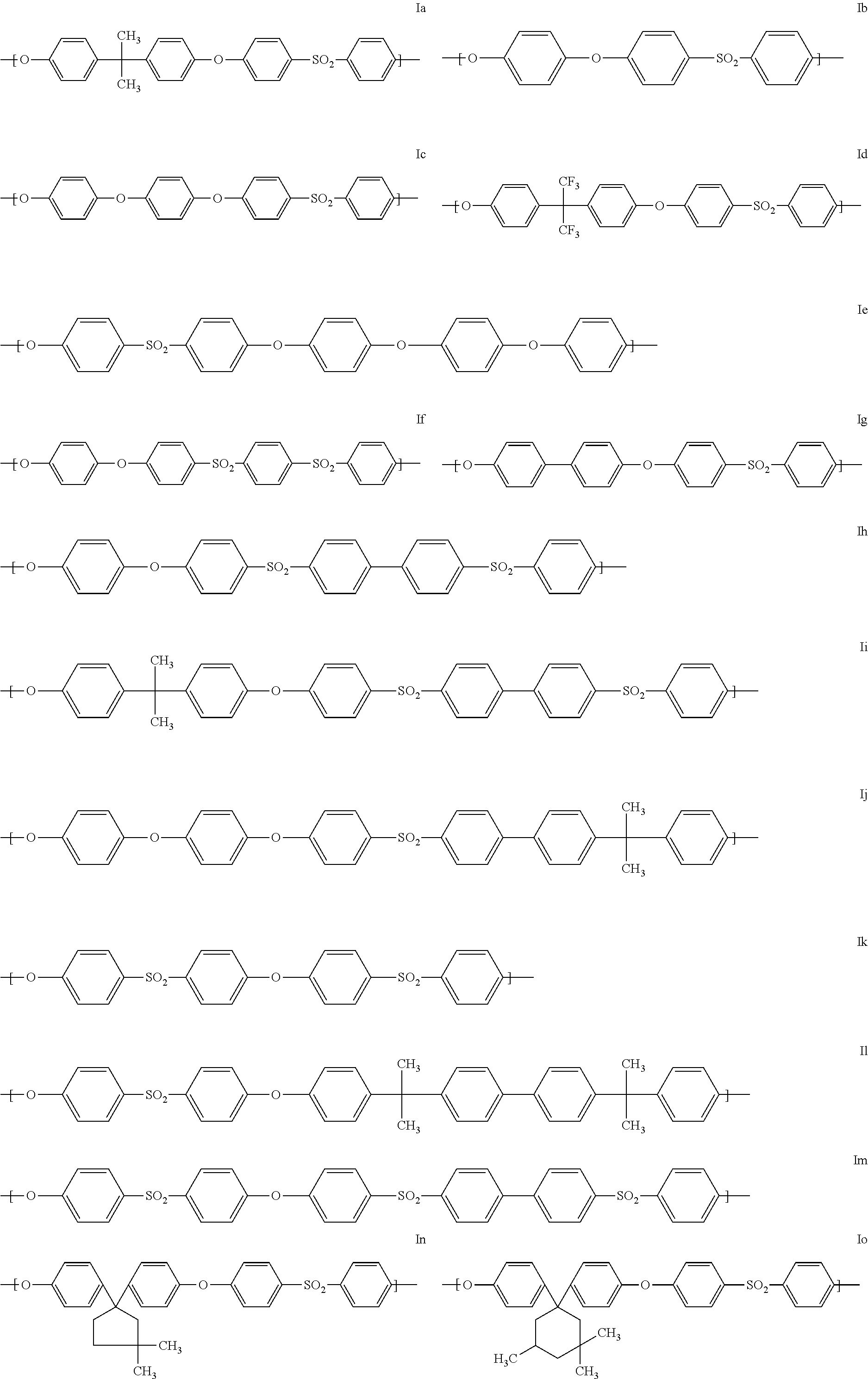

In addition to the preferred units Ia to Io, preference is also given to those units in which one or more 1,4-phenylene units which originate from hydroquinone are replaced by 1,3-phenylene units which originate from resorcinol or by naphthylene units which originate from dihydroxynaphthalene.

Particularly preferred units of the general formula (I) are the units Ia, Ig and Ik. It is also particularly preferred when the polyaryl ethers are formed essentially from one kind of units of the general formula (I), especially from a unit selected from Ia, Ig and Ik.

In a particularly preferred embodiment, Ar=1,4-phenylene, t=1, q=0, T is a chemical bond and Y═SO₂. Particularly preferred polyaryl ether sulfones formed from the aforementioned repeat unit are referred to as polyphenylene sulfone (PPSU) (formula Ig).

In a further particularly preferred embodiment, Ar=1,4-phenylene, t=1, q=0, T=C(CH₃)₂ and Y═SO₂. Particularly preferred polyaryl ether sulfones formed from the aforementioned repeat unit are referred to as polysulfone (PSU) (formula Ia).

In a further particularly preferred embodiment, Ar=1,4-phenylene, t=1, q=0, T=Y═SO₂. Particularly preferred polyaryl ether sulfones formed from the aforementioned repeat unit are referred to as polyether sulfone (PESU) (formula Ik).

Abbreviations such as PPSU, PSU and PESU in the context of the present invention conform to DIN EN ISO 1043-1 (Plastics—Symbols and abbreviated terms—Part 1: Basic polymers and their special characteristics (ISO 1043-1:2001); German version EN ISO 1043-1:2002).

The polyaryl ethers preferably have weight-average molecular weights M, of 10 000 to 150 000 g/mol, especially of 15 000 to 120 000 g/mol, more preferably of 18 000 to 100 000 g/mol, determined by means of gel permeation chromatography in a dimethylacetamide solvent against narrow-distribution polymethylmethacrylate as standard.

The polyaryl ethers preferably have a number-average molecular weight M, of 10 000 to 35 000 g/mol, determined by means of gel permeation chromatography in a dimethylacetamide solvent against narrow-distribution polymethylmethacrylate as standard.

The polydispersity is preferably from 1.9 to 7.5, more preferably from 2.1 to 4.

In addition, the polyaryl ethers in pure substance preferably have an apparent melt viscosity at 350° C./1150 s⁻¹ of 100 to 1000 Pa s, preferably of 150 to 300 Pa s and especially preferably of 150 to 275 Pa s.

The melt viscosity was determined by means of a capillary rheometer. The apparent viscosity was determined at 350° C. as a function of the shear rate in a capillary viscometer (GOttfert Rheograph 2003 capillary viscometer) with a circular capillary of length 30 mm, a radius of 0.5 mm, a nozzle inlet angle of 180°, a diameter of the reservoir vessel for the melt of 12 mm and with a preheating time of 5 minutes. The values reported are those determined at 1150 s⁻¹.

Preparation methods which lead to the aforementioned polyaryl ethers are known per se to those skilled in the art and are described, for example, in Herman F. Mark, “Encyclopedia of Polymer Science and Technology”, third edition, Volume 4, 2003, “Polysulfones” chapter on pages 2 to 8, and in Hans R. Kricheldorf, “Aromatic Polyethers” in: Handbook of Polymer Synthesis, second edition, 2005, on pages 427 to 443.

Polyaryl ethers are preferably prepared by the reaction of a component (a1) comprising at least one aromatic dihydroxyl compound and a compound (a2) comprising at least one aromatic sulfone compound having two halogen substituents. The molar ratio of components (a1) to (a2) is preferably in the range from 0.99 to 1.4, more preferably in the range from 1.0 to 1.2 and most preferably in the range from 1.0 to 1.1.

The reaction is typically conducted in the presence of a carbonate compound (C).

Component (a1) comprises at least one aromatic dihydroxyl compound. Component (a1) especially comprises the following compounds:
4,4′-dihydroxybiphenyl;
dihydroxybenzenes, especially hydroquinone and resorcinol;
dihydroxynaphthalenes, especially 1,5-dihydroxynaphthalene, 1,6-dihydroxynaphthalene, 1,7-dihydroxynaphthalene and 2,7-dihydroxynaphthalene;
dihydroxybiphenyls other than 4,4′-biphenol, especially 2,2′-biphenol;
bisphenyl ethers, especially bis(4-hydroxyphenyl) ether and bis(2-hydroxyphenyl) ether;
bisphenylpropanes, especially 2,2-bis(4-hydroxyphenyl)propane, 2,2-bis(3-methyl-4-hydroxyphenyl)propane and 2,2-bis(3,5-dimethyl-4-hydroxyphenyl)propane;
bisphenylmethanes, especially bis(4-hydroxyphenyl)methane;
bisphenylcyclohexanes, especially bis(4-hydroxyphenyl)-2,2,4-trimethylcyclohexane;
bisphenyl sulfones, especially bis(4-hydroxyphenyl) sulfone;
bisphenyl sulfides, especially bis(4-hydroxyphenyl) sulfide;
bisphenyl ketones, especially bis(4-hydroxyphenyl) ketone;
bisphenylhexafluoropropanes, especially 2,2-bis(3,5-dimethyl-4-hydroxyphenyl)hexafluoropropane; and
bisphenyfluorenes, especially 9,9-bis(4-hydroxyphenyl)fluorene.

Preferably, component (a1) comprises at least 50% by weight, more preferably at least 60% by weight, particularly preferably at least 80% by weight and especially at least 95% by weight of at least one dihydroxyl component selected from the group consisting of 4,4′-dihydroxybiphenyl, 2,2-bis(4-hydroxyphenyl)propane and bis(4-hydroxyphenyl) sulfone, based in each case on the total weight of component (a1). Most preferably, component (a1) consists of at least one dihydroxyl component selected from the group consisting of 4,4′-dihydroxybiphenyl, 2,2-bis(4-hydroxyphenyl)propane and bis(4-hydroxyphenyl) sulfone.

2,2-Bis(4-hydroxyphenyl)propane is also known by the name bisphenol A. Bis(4-hydroxyphenyl) sulfone is also known by the name bisphenol S.

Preferably, component (a2) comprises at least 50% by weight, preferably at least 60% by weight, more preferably at least 80% by weight and especially at least 95% by weight of at least one aromatic sulfone compound having two halogen substituents, based in each case on the total weight of component (a2).

Aromatic sulfone compounds having two halogen substituents that are suitable as component (a2) are known in principle to those skilled in the art. Preferred components (a2) are especially dihalodiphenyl sulfones such as 4,4′-dichlorodiphenyl sulfone, 4,4′-difluorodiphenyl sulfone, 4,4′-dibromodiphenyl sulfone, 2,2′-dichlorodiphenyl sulfone and 2,2′-difluorodiphenyl sulfone. 4,4′-Dichlorodiphenyl sulfone and 4,4′-difluorodiphenyl sulfone are particularly preferred. Very particular preference is given to 4,4′-dichlorodiphenyl sulfone.

The reaction of 4,4′-dihydroxybiphenyl as component (a1) and 4,4′-dihalodiphenyl sulfone as component (a2) gives polyphenylene sulfone (PPSU) as polyaryl ether sulfone (formula Ig).

The reaction of bisphenol A as component (a1) and 4,4′-dihalodiphenyl sulfone as component (a2) gives polysulfone (PSU) as polyaryl ether sulfone (formula Ia).

The reaction of bisphenol S as component (a1) and 4,4′-dihalodiphenyl sulfone as component (a2) gives polyether sulfone (PESU) as polyaryl ether sulfone (formula Ik).

Preferred polyaryl ether sulfones are polyphenylene sulfone (PPSU) and polyether sulfone (PESU).

The polyaryl ethers may have a number of different end groups. For example, they may have hydroxide end groups, halogen end groups and/or alkoxide end groups. If the polyaryl ethers, after the production process, are reacted with an etherifying agent, the polyaryl ethers may also have ether end groups. Suitable etherifying agents are known to those skilled in the art and are, for example, organic monohalogen compounds.

Preferred etherifying agents are selected from the group consisting of chloromethane, bromomethane, iodomethane and dimethyl carbonate.

Suitable carbonate compounds (C) are known as such to those skilled in the art. Preferred carbonate compounds (C) are alkali metal carbonates and/or alkaline earth metal carbonates. Preferably, the carbonate compounds (C) are anhydrous. Suitable carbonate compounds (C) are especially anhydrous alkali metal carbonate, preferably anhydrous sodium carbonate, anhydrous potassium carbonate or mixtures thereof, very particular preference being given to anhydrous potassium carbonate.

The salt-containing polymer (SP) comprising the polyaryl ether and the salt (S) can be prepared in the presence of a solvent or diluent; preparation is likewise possible in the absence of a solvent or diluent. Preference is given to preparation in the absence of a solvent or diluent. Particular preference is given to preparation in the absence of a solvent or diluent as a melt polymerization method.

Methods for preparing polyaryl ethers in the presence of a solvent or diluent are known as such to those skilled in the art. In one embodiment of the invention, they can also be used for preparation of the salt-containing polymer (SP). For this purpose, component (a1) and component (a2) are converted in an aprotic polar solvent in the presence of a carbonate compound (C). The solvent may optionally also comprise an azeotroping agent which forms an azeotrope with the water formed in the condensation reaction. Suitable aprotic polar solvents are, for example, selected from the group consisting of N,N-dimethylformamide, N,N-dimethylacetamide, N-methylpyrrolidone, N-ethylpyrrolidone, dimethyl sulfoxide, dimethyl sulfone, sulfolane and diphenyl sulfone. Suitable azeotroping agents are, for example, toluene and/or chlorobenzene.

The salt-containing polymers (SP) thus prepared can then be precipitated, for example, in water by methods known to those skilled in the art.

In a preferred embodiment, the salt-containing polymers (SP) are prepared in the absence of solvents or diluents. They are more preferably prepared in a melt polymerization process. Melt polymerization processes for polyaryl ethers are described, for example, in DE 2 749 645 and in WO 2014/033321 and can be used in a preferred embodiment of the present invention for preparation of the salt-containing polymer (SP).

The present invention thus also provides a process in which the salt-containing polymer (SP) is prepared by a melt polymerization method.

The melt polymerization can be performed as a batchwise process or as a continuous process. Preference is given to performance as a continuous process.

Suitable reactors are all known reactor types which are suitable for mixing high-viscosity materials and also allow removal of gaseous condensation products and heating of the monomers above the melting point thereof. Preferred reactors are extruders or mixing kneaders, particular preference being given to mixing kneaders. Preference is also given to single- or twin-shaft kneaders, particular preference being given to twin-shaft kneaders. It is further preferable that the mixing kneader is additionally equipped with a reflux condenser in order to recycle volatile monomer which may have evaporated at the reaction temperatures into the mixing kneader.

Typically, the melt polymerization is conducted at a temperature below the decomposition temperature of the polyaryl ether. Preferably, the temperature in the melt polymerization is at least 1° C., preferably at least 5° C. and especially preferably at least 10° C. below the decomposition temperature of the polyaryl ether.

In general, the melt polymerization is conducted at a temperature in the range from 200 to 400° C., preferably in the range from 250 to 350° C.

In one embodiment, component (a1) and component (a2) are initially charged in the mixing kneader in a molar ratio of 0.99 to 1.4, preferably of 1.0 to 1.2 and especially preferably of 1.0 to 1.1. The carbonate compound (C) is then added as a separate component. Preferably, the carbonate compound (C) is fed in a molar ratio relative to component (a1) of 0.9 to 1.22, preferably of 1.0 to 1.12 and especially preferably of 1.03 to 1.10.

If component (a1) and component (a2) are initially charged in the mixing kneader, it is preferable that components (a1) and (a2) are first melted and then the carbonate compound (C) is fed in. Preferably, components (a1) and (a2) are mixed with one another and melted and only then fed to the mixing kneader.

It is also possible to initially charge the carbonate compound (C) with one of the two components (a1) and (a2) and then to add the second of the two components (a1) and (a2). It is especially preferable to initially charge the carbonate compounds (C) with component (a1). In that case, component (a1) is generally first reacted with the carbonate compound (C) to form a dialkoxide and then component (a2) is added.

With regard to the molar ratio of the two components (a1) and (a2) and the carbonate compound (C), the above-described details and preferences apply, even when the carbonate compound (C) is initially charged with one of the two components (a1) and (a2).

Component (a1) and/or (a2) can be introduced into the mixing kneader in liquid or solid form.

The reaction time in the reactor is generally 0.5 to 3.5 hours, preferably 1 to 2 hours.

In the reaction of component (a1) with component (a2) in the presence of the carbonate compound (C), condensation products formed in addition to the polyaryl ether are water, carbon dioxide and the salt (S). The water formed and the carbon dioxide formed can be removed from the reactor as gaseous constituents during the reaction. The salt (S) generally remains in the polyaryl ether when the salt-containing polymer (SP) is obtained. In general, the salt (S) is an inorganic salt when the carbonate compound (C) used is an inorganic carbonate compound (C). Preferably, the salt (S) is an alkali metal halide when the carbonate compound (C) used is an alkali metal carbonate. Most preferably, the salt (S) is potassium chloride and/or sodium chloride when the carbonate compound (C) used is potassium carbonate and/or sodium carbonate.

The present invention thus also provides a method in which the salt (S) comprises an inorganic salt.

The present invention further provides a method in which the salt (S) comprises potassium chloride and/or sodium chloride.

The salt (S) generally has a particle size in the range from 0.1 to 100 μm, preferably in the range from 0.5 to 50 μm, more preferably in the range from 0.8 to 30 μm and most preferably in the range from 1 to 10 μm. The particle size is determined by SEM (scanning electron microscopy) imaging at an acceleration voltage of 8 kV.

The salt (S) is generally dispersed in particulate form in the salt-containing polymer (SP).

Method Step a)

The salt-containing polymer (SP) used in method step a) is generally prepared by a melt polymerization method.

According to the invention, the salt-containing polymer (SP) used in method step a) has a surface area.

In method step a), the surface area of the salt-containing polymer (SP) is mechanically increased to obtain a salt-containing polymer of increased surface area (SPISA).

The salt-containing polymer of increased surface area (SPISA) comprises the polyaryl ether and the salt (S) that were already present in the salt-containing polymer (SP).

In the present context, “increasing the surface area” is understood to mean that the ratio (R1) of the surface area of the salt-containing polymer of increased surface area (SPISA) to the weight of the salt-containing polymer of increased surface area (SPISA) is greater than the ratio (R2) of the surface area of the salt-containing polymer (SP) to the weight of the salt-containing polymer (SP).

In other words, R1>R2, where

$$R 1 = \frac{surface area of the salt \text{-} containing polymer of increased surface area ( SPISA ) ⌊ {mm}^{2} ⌋}{weight of the salt \text{-} containing polymer of increased surface area ( SPISA ) [ g ]}$$

$$and$$

$$R 1 = \frac{surface area of the salt \text{-} containing polymer of increased surface area ( SPISA ) ⌊ {mm}^{2} ⌋}{weight of the salt \text{-} containing polymer of increased surface area ( SPISA ) [ g ]}$$

In other words, this means that the surface area of, for example, 1 kg of the salt-containing polymer of increased surface area (SPISA) is greater than the surface area of, for example, likewise 1 kg of the salt-containing polymer (SP).

In method step a), the ratio (R2) of the surface area of the salt-containing polymer (SP) to the weight of the salt-containing polymer (SP) is increased mechanically generally by 0.1% to 10 000%, preferably by 100% to 8000% and more preferably by 250% to 5000%. The surface area is determined in each case by means of SEM.

Preferably in accordance with the invention, the surface area is mechanically increased by foaming or drawing the salt-containing polymer (SP).

The present invention thus also provides a method wherein the surface area of the salt-containing polymer (SP) is increased in method step a) by foaming or drawing the salt-containing polymer (SP).

In one embodiment of the present invention, the surface area of the salt-containing polymer (SP) is not mechanically increased by grinding the salt-containing polymer (SP).

To mechanically increase the surface area of the salt-containing polymer (SP), the salt-containing polymer (SP) is introduced into an extruder. The preparation of the salt-containing polymer (SP) and the introduction of the salt-containing polymer (SP) into the extruder may either be batchwise or continuous. Preferably, the preparation of the salt-containing polymer (SP) and the introduction of the salt-containing polymer (SP) into the extruder are continuous.

In the present context, “batchwise” is understood to mean that the salt-containing polymer (SP) is first prepared in a batchwise process or in a continuous process as described above and then processed to give solid polymer, for example in the form of pellets or powder. This powder or pellet material is then introduced into the extruder.

In the present context, “continuous” is understood to mean that the salt-containing polymer (SP) directly after it has been prepared, preferably after it has been prepared by melt polymerization, especially preferably after it has been prepared by melt polymerization in a continuous method, is transferred into the extruder. In general, the salt-containing polymer (SP) is transferred into the extruder as a melt, i.e. without allowing the salt-containing polymer (SP) to solidify or grinding it or pelletizing it.

Preferably, the mixing kneader in which the melt polymerization takes place comprises the extruder.

The present invention thus also provides a process in which the salt-containing polymer (SP) used in method step a) is prepared by a method comprising the steps of
a1) preparing the salt-containing polymer (SP) by a melt polymerization method,
a2) introducing the salt-containing polymer (SP) produced in method step a1) into an extruder.

The present invention also provides a method in which method step a1) and method step a2) are conducted continuously.

The present invention further provides a method in which the salt-containing polymer (SP) prepared in method step a1) is in the form of a melt and is introduced into the extruder as a melt in method step a2).

Suitable extruders are in principle any extruders known to those skilled in the art. The extruder may also have static and/or dynamic mixing units. Static and/or dynamic mixing units are known as such to those skilled in the art. Static mixing units are, for example, static mixers; dynamic mixing units are, for example, twin-shaft extruders.

Preference is given in accordance with the invention to dynamic mixing units; twin-shaft extruders are especially preferred.

The temperature in the extruder and any static and/or dynamic mixing unit present is generally in the range from 200 to 400° C., preferably in the range from 250 to 350° C. The salt-containing polymer (SP) is therefore generally in molten form in the extruder.

After the introduction of the salt-containing polymer (SP) into the extruder, the surface area of the salt-containing polymer (SP) can be increased by foaming or drawing the salt-containing polymer.

In order to draw the salt-containing polymer (SP), the salt-containing polymer (SP) is extruded out of the extruder. The extrusion affords at least one strand of the salt-containing polymer (SP). The latter is subsequently cooled. The cooling can be effected, for example, under air or in a water bath.

The at least one strand of the salt-containing polymer (SP) obtained in the extrusion, after cooling, can be drawn while heating. It is likewise possible and preferable in accordance with the invention to draw the at least one strand of the salt-containing polymer (SP) as early as during cooling, for example under air or in a water bath, to obtain at least one strand of the salt-containing polymer of increased surface area (SPISA).

If the at least one strand of the salt-containing polymer (SP) is drawn while heating after cooling, the temperatures during the drawing are generally in the range from 150 to 350° C., preferably in the range from 180 to 320° C.

Preferably, the drawing of the at least one strand of the salt-containing polymer (SP) is conducted during the cooling of the at least one strand of the salt-containing polymer (SP). In that case, the temperatures during the drawing are preferably in the range from 150 to 350° C. and more preferably in the range from 180 to 320° C.

Suitable methods for drawing the at least one strand of the salt-containing polymer (SP) are in principle all methods known to those skilled in the art. In general, the at least one strand of the salt-containing polymer (SP) is drawn by guiding it through a roller system, which reduces the diameter of the at least one strand of the salt-containing polymer (SP) and increases the length of the salt-containing polymer (SP) and hence also the surface area of the salt-containing polymer (SP). In the course of this, the salt-containing polymer (SP) solidifies. During the drawing with simultaneous solidification, the polymer chains present in the salt-containing polymer (SP) become aligned and small polymer filaments form, which increases the surface area of the salt-containing polymer (SP).

The present invention thus also provides a method in which method step a) comprises the following steps:
ai) extruding the salt-containing polymer (SP) out of an extruder to obtain at least one strand of the salt-containing polymer (SP),
aii) drawing the at least one strand of the salt-containing polymer (SP) by guiding the at least one strand of the salt-containing polymer (SP) through a roller system to obtain at least one strand of the salt-containing polymer of increased surface area (SPISA).

The present invention further provides a method in which method step aii) is conducted during the cooling of the at least one strand of the salt-containing polymer (SP).

During the drawing, the cross-sectional area of the at least one strand of the salt-containing polymer (SP) is reduced, such that the at least one strand of the salt-containing polymer of increased surface area (SPISA) has a smaller cross-sectional area than the at least one strand of the salt-containing polymer (SP). In general, the cross-sectional area of the at least one strand of the salt-containing polymer of increased surface area (SPISA) is reduced with respect to the cross-sectional area of the strand of the salt-containing polymer (SP) by 10% to 99%, preferably by 30% to 95% and more preferably by 50% to 90%.

The cross-sectional area of the at least one strand of the salt-containing polymer (SP) is generally in the range from 1 to 30 mm², preferably in the range from 2 to 20 mm² and especially preferably in the range from 5 to 15 mm².

According to the invention, the cross-sectional area of the at least one strand of the salt-containing polymer of increased surface area (SPISA) is less than the cross-sectional area of the at least one strand of the salt-containing polymer (SP). The cross-sectional area of the at least one strand of the salt-containing polymer of increased surface area (SPISA) is generally in the range from 0.005 to 2 mm², preferably in the range from 0.01 to 0.5 mm² and especially preferably in the range from 0.02 to 0.1 mm².

The ratio (R1) of the surface area of the salt-containing polymer of increased surface area (SPISA) after drawing to the weight of the salt-containing polymer of increased surface area (SPISA) after drawing as compared with the ratio (R2) of the surface area of the salt-containing polymer (SP) directly after extrusion and before drawing to the weight of the salt-containing polymer (SP) directly after extrusion and before drawing is generally increased by 50% to 10 000%, preferably by 100% to 5000% and more preferably by 250% to 5000%.

Suitable methods for foaming the salt-containing polymer (SP) are in principle all methods known to those skilled in the art. In one embodiment, the salt-containing polymer (SP) is mixed with a blowing agent in the extruder to obtain a blowing agent-containing salt-containing polymer (BSP). The above-described details and preferences apply with regard to the extruder and the addition of the salt-containing polymer (SP).

As described above, the extruder, in one embodiment of the present invention, may comprise static and/or dynamic mixing units. It will therefore be clear to the person skilled in the art that the salt-containing polymer (SP) can not only be mixed with the blowing agent in the extruder as such, but that it is likewise possible that the salt-containing polymer (SP) is mixed with the blowing agent in the static and/or dynamic mixing unit comprising the extruder.

According to the invention, “a blowing agent” is understood to mean either exactly one blowing agent or two or more blowing agents. A suitable blowing agent is, for example, selected from the group consisting of water, carbon dioxide, pentane and nitrogen. A preferred blowing agent is nitrogen and/or carbon dioxide.

In general, 1% to 20% by weight, preferably 2% to 15% by weight and more preferably 3% to 10% by weight of a blowing agent are mixed with the salt-containing polymer (SP), based in each case on the total molar amount of the salt-containing polymer (SP).

While the salt-containing polymer (SP) is being mixed with the blowing agent in the extruder, the pressure in the extruder is generally in the range from 5 to 100 bar, preferably in the range from 10 to 80 bar and more preferably in the range from 15 to 50 bar.

The temperature in the extruder while the salt-containing polymer (SP) is being mixed with the blowing agent is generally in the range from 200 to 400° C., preferably in the range from 250 to 350° C.

Preferably, after the mixing, the blowing agent is in a homogeneous distribution in the blowing agent-containing salt-containing polymer (BSP).

When the blowing agent has been mixed with the salt-containing polymer (SP) in the extruder, the resultant blowing agent-containing salt-containing polymer (BSP) can subsequently be extruded. In the course of extrusion, the blowing agent-containing salt-containing polymer (BSP) is expanded as it exits from the extruder orifice, since the blowing agent escapes from the blowing agent-containing salt-containing polymer (BSP). This affords the salt-containing polymer of increased surface area (SPISA). The expanding of the blowing agent-containing salt-containing polymer (BSP) is also referred to as foaming.

The present invention thus also provides a method in which method step a) comprises the following steps:
al) mixing the salt-containing polymer (SP) in an extruder with a blowing agent to obtain a blowing agent-containing salt-containing polymer (BSP),
all) extruding the blowing agent-containing salt-containing polymer (BSP) out of the extruder,
alll) foaming the blowing agent-containing salt-containing polymer (BSP) to obtain the salt-containing polymer of increased surface area (SPISA).

In general, the foaming of the blowing agent-containing salt-containing polymer (BSP) directly follows the exit of the blowing agent-containing salt-containing polymer (BSP) from the extruder as a result of the decompression in a downstream die.

The present invention thus also provides a method in which method steps all) and alll) are conducted simultaneously.

The salt-containing polymer of increased surface area (SPISA) produced by foaming generally has a lower density and a greater volume than the salt-containing polymer (SP) which does not comprise any blowing agent and is extruded through an orifice of the same diameter as the blowing agent-containing salt-containing polymer (BSP).

Typically, the density of the salt-containing polymer of increased surface area (SPISA) is 30% to 80% less than that of the salt-containing polymer (SP) which does not comprise any blowing agent and is extruded through an orifice of the same diameter as the blowing agent-containing salt-containing polymer (BSP), preferably 35% to 70% less and more preferably 40% to 65% less.

In addition, the foaming increases the surface area of the foamed salt-containing polymer (SP) compared to the surface area of the salt-containing polymer (SP) which does not comprise any blowing agent and is extruded through a round die of the same diameter as the blowing agent-containing salt-containing polymer (BSP).

The surface area of the salt-containing polymer of increased surface area (SPISA) produced by foaming is thus greater than that of the salt-containing polymer (SP) which does not comprise any blowing agent and is extruded through a round die of the same diameter as the blowing agent-containing salt-containing polymer (BSP).

The ratio (R1) of the surface area of the salt-containing polymer of increased surface area (SPISA) produced by foaming to the weight of the salt-containing polymer of increased surface area (SPISA) produced by foaming is thus increased compared to the ratio (R2) of the surface area of the salt-containing polymer (SP) which does not comprise any blowing agent and is extruded through an orifice of the same diameter as the blowing agent-containing salt-containing polymer (BSP) to the weight of the salt-containing polymer (SP) which does not comprise any blowing agent and is extruded through an orifice of the same diameter as the blowing agent-containing salt-containing polymer (BSP).

Preferably, the ratio (R1) of the surface area of the salt-containing polymer of increased surface area (SPISA) produced by foaming to the weight of the salt-containing polymer of increased surface area (SPISA) produced by foaming as compared with the ratio (R2) of the surface area of the salt-containing polymer (SP) which does not comprise any blowing agent and is extruded through an orifice of the same diameter as the blowing agent-containing salt-containing polymer (BSP) to the weight of the salt-containing polymer (SP) which does not comprise any blowing agent and is extruded through an orifice of the same diameter as the blowing agent-containing salt-containing polymer (BSP) is increased by 100% to 10 000%, more preferably by 200% to 8000% and most preferably by 500% to 5000%.

After the mechanical increase in the surface area of the salt-containing polymer (SP) in method step a), the resultant salt-containing polymer of increased surface area (SPISA) is optionally comminuted. Method step a) thus optionally also comprises a comminution of the salt-containing polymer of increased surface area (SPISA). This can be effected by methods known to those skilled in the art. Preference is given to comminution by pelletization or grinding, more preferably by pelletization. Suitable methods for grinding are in principle all methods known to those skilled in the art, for example hammer mills, vibratory mills and rotor mills. Pelletization can be effected, for example, by strand pelletization or by underwater pelletization. Methods for this purpose are known to those skilled in the art.

In general, the salt-containing polymer of increased surface area (SPISA) is comminuted to a particle size in the range from 0.1 to 10 mm, preferably to a particle size in the range from 0.5 to 7 mm and more preferably to a particle size in the range from 0.75 to 5 mm.

Method Step b)

In method step b), the salt-containing polymer of increased surface area (SPISA) from method step a) is contacted with an extractant (E), and a desalinated polymer (DP) comprising the polyaryl ether, and a salt-containing extractant (SE) comprising the extractant (E) and the salt (S) are obtained.

Method step b) is an extraction. The terms “method step b)” and “extraction” are therefore used synonymously hereinafter.

Preferably, method step b) is conducted directly after method step a).

The extractant (E) used may be exactly one extractant; it is likewise possible to use a mixture of two or more extractants.

A suitable extractant (E) is in principle any solvent that dissolves the salt (S). Preferably, the extractant (E) comprises a protic solvent. More preferably, the extractant (E) comprises water.

The present invention thus also provides a process in which the extractant (E) used is a protic solvent.

In general, the extractant (E) comprises at least 50% by weight of water, preferably at least 70% by weight of water, especially preferably at least 80% by weight of water and most preferably at least 90% by weight of water, based in each case on the total weight of the extractant (E).

The present invention thus also provides a method in which the extractant (E) in method step b) comprises water.

In a most preferred embodiment, the extractant (E) consists of water.

The salt-containing polymer of increased surface area (SPISA) is generally contacted with the extractant (E) in a reactor. Suitable reactor types for this purpose are in principle any known to those skilled in the art, for example stirred tank reactors and tubular reactors. Preference is given in accordance with the invention to tubular reactors.

It is also preferable that the reactor used in method step b) can be heated from the outside to the temperature at which the extraction of the salt-containing polymer of increased surface area (SPISA) with the extractant (E) takes place.

According to the invention, the reactor can optionally also be equipped, for example, with centrifuges and/or filters in order to separate the salt-containing extractant (SE) obtained in method step b) from the desalinated polymer (DP) obtained in method step b).

The salt-containing polymer of increased surface area (SPISA) may take the form of a fixed bed in the reactor, such that the reactor used is a fixed bed reactor. It is likewise possible and preferable in accordance with the invention to use a countercurrent flow reactor in method step b).

Countercurrent reactors are known as such to those skilled in the art. In one embodiment of the present invention, the salt-containing polymer of increased surface area (SPISA) can, for example, be passed continuously through the countercurrent flow reactor and the extractant (E) can be fed in from the opposite direction.

If method step b) is conducted in a fixed bed reactor, the extractant (E) is passed through the reactor. In general, the extractant (E) is passed through the reactor from the bottom upward or from the top downward. Preferably, the extractant (E) is passed through the reactor from the bottom upward.

If a countercurrent flow reactor is used, the salt-containing polymer of increased surface area (SPISA) is generally introduced into the reactor continuously from the top and removed therefrom at the bottom, while the extractant (E) is simultaneously conducted into the reactor from the bottom and flows out at the top.

The residence time of the salt-containing polymer of increased surface area (SPISA) in the countercurrent flow reactor is generally adjusted such that the salt-containing polymer of increased surface area (SPISA) in the reactor behaves at least at times like a fixed bed.

In the present context, residence time is understood to mean the time for which the salt-containing polymer of increased surface area (SPISA) remains in the countercurrent flow reactor.

The residence time of the salt-containing polymer of increased surface area (SPISA) in the countercurrent flow reactor can be adjusted, for example, via the rate at which the salt-containing polymer of increased surface area (SPISA) is introduced into the reactor. It can also be controlled via the volume of and the rate at which the extractant (E) is introduced into the reactor.

In general, the residence time of the salt-containing polymer of increased surface area (SPISA) in the countercurrent flow reactor is in the range from 20 to 140 hours, preferably in the range from 40 to 120 hours and more preferably in the range from 50 to 100 hours.

Method step b) is generally conducted at temperatures below the softening temperature (Tₛ) of the polyaryl ether.

The softening temperature (Tₛ) of the polyaryl ether is understood in the present context to mean the glass transition temperature of the pure polyaryl ether comprising 2% to 30% by weight of extractant (E), based on the total weight of the polyaryl ether, where the polyaryl ether does not comprise any salt (S).

The softening temperature (Tₛ) of the polyaryl ether can be determined analogously to the glass transition temperature of a polymer by means of dynamic differential calorimetry (DDC; differential scanning calorimetry, DSC). The methods for this purpose are known to those skilled in the art.

In general, the softening temperature (Tₛ) of the polyaryl ether is in the range from 155 to 230° C., preferably in the range from 160 to 180° C.

The present invention thus also provides a method in which method step b) is conducted at a temperature below the softening temperature (Tₛ) of the polyaryl ether.

In general, the extraction takes place at a temperature at least 1° C., preferably at least 5° C. and more preferably at least 10° C. below the softening temperature (Tₛ) of the polyaryl ether.

According to the invention, the temperature in the extraction is at least 50° C., preferably at least 70° C., more preferably at least 90° C. and especially preferably at least 100° C.

Preferably, method step b) is conducted at a temperature in the range from 50 to 159° C., preferably in the range from 70 to 155° C. and especially preferably in the range from 90 to 150° C.

Method step b) is generally conducted at an absolute pressure in the range from 1 to 10 bar, more preferably in the range from 1 to 7 bar, most preferably in the range from 1 to 5 bar.

In a preferred embodiment, method step b) is conducted for a period of time in the range from 20 to 150 hours, preferably in the range from 40 to 120 hours, most preferably in the range from 50 to 100 hours.

The ratio of the mass flow rate of the salt-containing polymer of increased surface area (SPISA) to the mass flow rate of the extractant (E) in method step b) is generally in the range from 1:1 to 1:100, preferably in the range from 1:3 to 1:20 and especially in the range from 1:5 to 1:10.

In general, the extractant (E) is brought to the temperature used for extraction before entry into the reactor. Suitable methods for this purpose are known to those skilled in the art.

The salt-containing polymer of increased surface area (SPISA) is typically likewise brought to the extraction temperature even before the addition to the reactor. It is also possible to additionally heat the reactor from the outside, in order to keep the temperature in method step b) within the necessary temperature range.

The salt-containing extractant (SE) obtained in method step b) comprises the portion of the salt (S) which has been removed from the salt-containing polymer (SP). In general, the salt-containing extractant (SE) comprises 0.1% to 20% by weight of the salt (S), preferably 0.5% to 10% by weight of the salt (S) and especially preferably 1% to 5% by weight of the salt (S), based in each case on the total weight of the salt-containing extractant (SE).

In a further embodiment which is preferred in accordance with the invention, method step b) is conducted in a plurality of steps. In this case, the temperatures and pressures in the individual stages may differ.

The present invention thus also provides a method in which method step b) comprises the following steps:
b1) contacting the salt-containing polymer of increased surface area (SPISA) from method step a) with the extractant (E) to obtain a pre-desalinated polymer (PDP) comprising the polyaryl ether and residues of the salt (S), and a first salt-containing extractant (SE1) comprising the extractant (E) and a portion of the salt (S),
b2) contacting the pre-desalinated polymer (PDP) from method step b1) with the extractant (E) to obtain the desalinated polymer (DP) comprising the polyaryl ether, and a second salt-containing extractant (SE2) comprising the extractant (E) and the residues of the salt (S).

In method step b1), the salt-containing polymer of increased surface area (SPISA) from method step a) is contacted with the extractant (E). The same details and preferences as described above for method step b) apply to the reactor in which method step b1) is conducted and the extractant (E).

Method step b1) is also referred to as pre-extraction. The terms “method step b1)” and “pre-extraction” are used synonymously hereinafter.

Method step b1) is generally conducted at a temperature in the range from 50 to 105° C., preferably in the range from 60 to 100° C. and especially preferably in the range from 70 to 100° C.

The present invention thus also provides a method in which method step b1) is conducted at a temperature in the range from 50 to 105° C.

The absolute pressure in the reactor during method step b1) is preferably in the range from 1 to 2 bar, more preferably in the range from 1 to 1.5 bar, most preferably in the range from 1 to 1.2 bar.

In general, method step b1) is conducted for a period of time in the range from 5 to 50 hours, preferably in the range from 7 to 30 hours and especially preferably in the range from 10 to 20 hours.

The present invention thus also provides a method in which method step b1) is conducted for a period in the range from 5 to 50 hours.

The ratio of the mass flow rate of the salt-containing polymer of increased surface area (SPISA) to the mass flow rate of the extractant (E) in method step b1) is generally in the range from 1:1 to 1:100, preferably in the range from 1:3 to 1:20 and especially preferably in the range from 1:5 to 1:10.

The pre-extraction affords a pre-desalinated polymer (PDP) comprising the polyaryl ether and residues of the salt (S), and a first salt-containing extractant (SE1) comprising the extractant (E) and a portion of the salt (S).

The first salt-containing extractant (SE1) comprises the extractant (E) and the portion of the salt (S) which has been removed from the salt-containing polymer of increased surface area (SPISA). In general, the first salt-containing extractant (SE1) comprises 0.09% to 18% by weight of the salt (S), preferably 0.45% to 9% by weight of the salt (S) and especially preferably 0.9% to 4.5% by weight of the salt (S), based in each case on the total weight of the first salt-containing extractant (SE1).

“Residues of the salt (S)” are understood in accordance with the invention to mean 0.02% to 10% by weight of the salt (S), preferably 0.1% to 8% by weight of the salt (S) and especially preferably 0.2% to 6% by weight of the salt (S), based in each case on the total weight of the pre-desalinated polymer (PDP).

In other words, the pre-desalinated polymer obtained in method step b1) comprises generally 0.02% to 10% by weight of the salt (S), preferably 0.1% to 8% by weight of the salt (S) and especially preferably 0.2% to 6% by weight of the salt (S), based in each case on the total weight of the pre-desalinated polymer (PDP).

It will be apparent that the pre-desalinated polymer (PDP) comprises less salt (S) than the salt-containing polymer (SP) and the salt-containing polymer of increased surface area (SPISA).

If the salt-containing polymer (SP) comprises less than 5% by weight of the salt (S) based on the total weight of the salt-containing polymer (SP), method step b1) is generally not conducted.

In method step b2), the pre-desalinated polymer (PDP) from method step b1) is contacted with the extractant (E). The same details and preferences as described above for method step b) apply to the reactors used in method step b2) and to the extractant (E).

Preferably, method step b2) is conducted directly after method step b1). Especially preferably, method step b2) is conducted in a reactor separated from the reactor in which method step b1) is conducted, the two reactors being in direct succession. In a very particularly preferred embodiment, method step b1) and method step b2) are conducted as a continuous countercurrent flow extraction.

In general, method step b2) is conducted at a temperature in the range from >105° C. to <Tₛ, where “Tₛ” is understood to mean the softening temperature (Tₛ) of the polyaryl ether as already described above.

In general, method step b2) is conducted at a temperature at least 1° C., preferably at least 5° C. and especially preferably at least 10° C. below the softening temperature (Tₛ) of the polyaryl ether.

Preferably, the temperature during method step b2) is in the range from >105 to 159° C., more preferably in the range from 115 to 155° C. and especially preferably in the range from 125 to 150° C.

The present invention thus also provides a method in which method step b2) is conducted at a temperature in the range from >105° C. to <Tₛ. The pressure in method step b2) is generally in the range from 1 to 10 bar, preferably in the range from 1.5 to 7 bar and especially preferably in the range from 2 to 5 bar.

In one embodiment of the invention, method step b2) is conducted for a period of 10 to 90 hours, preferably in the range from 20 to 80 hours and especially preferably in the range from 30 to 60 hours.

The present invention further provides a method in which method step b2) is conducted for a period in the range from 10 to 90 hours.

The ratio of the mass flow rate of the salt-containing polymer of increased surface area (SPISA) to the mass flow rate of the extractant (E) in method step b2) is generally in the range from 1:1 to 1:100, preferably in the range from 1:3 to 1:20 and especially preferably in the range from 1:5 to 1:10.

In method step b2), the desalinated polymer (DP) comprising the polyaryl ether and a second salt-containing extractant (SE2) comprising the extractant (E) and the residues of the salt (S) are obtained.

The second salt-containing extractant (SE2) comprises the residues of the salt (S) which have been removed from the pre-desalinated polymer (PDP). In general, the second salt-containing extractant (SE2) comprises 0% to 2% by weight of the salt (S), preferably 0% to 1.5% by weight of the salt (S) and especially preferably 0% to 1% by weight of the salt (S), based in each case on the total weight of the second salt-containing extractant (SE2).

In one embodiment of the present invention, the second salt-containing extractant (SE2) can be used as extractant (E) in method step b1).

It will be apparent that the desalinated polymer (DP) which is obtained in method step b) or in method step b2) comprises less salt (S) than the salt-containing polymer (SP) and any pre-desalinated polymer (PDP). In general, the desalinated polymer (DP) still comprises traces of the salt (S).

“Traces of the salt (S)” in the present case are understood to mean a salt content in the desalinated polymer (DP) of ≦150 ppm by weight, preferably ≦100 ppm by weight, especially preferably ≦80 ppm by weight and most preferably ≦50 ppm by weight of the salt (S), based in each case on the total weight of the desalinated polymer (DP).

In general, the desalinated polymer (DP) comprises 0.01 to 150 ppm by weight of the salt (S), preferably 0.1 to 100 ppm by weight, more preferably 1 to 80 ppm by weight and especially 5 to 50 ppm by weight of the salt (S), based in each case on the total weight of the desalinated polymer (DP).

In one embodiment of the present invention, the desalinated polymer (DP) comprises not more than 150 ppm by weight, preferably not more than 100 ppm by weight, especially preferably not more than 80 ppm by weight and most preferably not more than 50 ppm by weight of the salt (S).

The present invention thus also provides a method in which the desalinated polymer (DP) obtained in method step b) comprises not more than 150 ppm by weight of the salt (S), based on the total weight of the desalinated polymer (DP).

The lower limit of the content of salt (S) in the desalinated polymer (DP) is generally 0.01 ppm by weight, preferably 0.1 ppm by weight, more preferably 1 ppm by weight and especially preferably 5 ppm by weight.

In an especially preferred embodiment, the desalinated polymer (DP) is essentially free of the salt (S). In the context of the present invention, “essentially free” means that the desalinated polymer (DP) comprises not more than 15 ppm by weight, preferably not more than 10 ppm by weight and especially preferably not more than 5 ppm by weight of the salt (S).

In one embodiment of the present invention, method step b) can be repeated. In this case, it can be repeated once or else more than once. It is likewise possible to repeat method step b1) and method step b2) once or more than once.

The desalinated polymer (DP) can be separated from the salt-containing extractant (SE) by methods known to those skilled in the art. For example, it can be separated from the salt-containing extractant (SE) by filtration or centrifugation.

It is also possible to dry the desalinated polymer (DP). Suitable methods for drying are in principle all methods known to those skilled in the art. For example, the desalinated polymer (DP) can be dried at elevated temperatures. Preference is given to temperatures in the range from 50 to 300° C., more preferably in the range from 100 to 200° C. The drying can optionally be conducted under reduced pressure.

The above-described details and preferences relating to the separation of the desalinated polymer (DP) from the salt-containing extractant (SE) apply to the separation of the desalinated polymer (DP) from the second salt-containing extractant (SE2).

When the salt-containing polymer (SP) has been prepared in a melt polymerization method, the salt-containing polymer (SP) and hence also the desalinated polymer (DP) does not comprise any solvent or diluent.

The present invention thus also provides a desalinated polymer (DP) comprising no solvent or diluent and less than 150 ppm by weight of the salt (S).

The present invention thus also provides a desalinated polymer (DP) obtainable by the method of the invention.

The desalinated polymers (DP) obtainable by the method of the invention preferably have an apparent melt viscosity at 350° C./1150 s⁻¹ of 100 to 1000 Pa s, preferably of 150 to 300 Pa s and especially preferably of 150 to 275 Pa s.

The melt viscosity was determined by means of a capillary rheometer. The apparent viscosity was determined at 350° C. as a function of the shear rate in a capillary viscometer (GOttfert Rheograph 2003 capillary viscometer) with a circular capillary of length 30 mm, a radius of 0.5 mm, a nozzle inlet angle of 180°, a diameter of the reservoir vessel for the melt of 12 mm and with a preheating time of 5 minutes. The values reported are those determined at 1150 s⁻¹.

The viscosity numbers of the polymers (DP) desalinated by the method of the invention are generally in the range from 20 to 120 mL/g, preferably from 30 to 100 mL/g and especially preferably from 35 to 95 mL/g, determined by Ubbelohde viscosity number measurement of a 0.01 g/mL solution of the salt-containing polymer (SP) in a 1:1 phenol/1,2-dichlorobenzene mixture in accordance with DIN 51562.

### EXAMPLES

In the tables, the symbols mean:
c proportion of the salt (S) in the salt-containing polymer (SP),
VN the viscosity number of the polymer,
t the period of time within which the desalination was conducted,
M_{w}/Mₙ the polydispersity,
M_{w} the weight-average molecular weight,
Mₙ the number-average molecular weight

VN, M_{w} and Mₙ were determined as described above.

Preparation of the Salt-Containing Polymers

The preparation of the salt-containing polymer (SP) for comparative example C1 and comparative example C2 was effected by a melt polymerization method in a kneading reactor. 4,4′-Dichlorodiphenyl sulfone (DCDPS) and 4,4′-dihydroxydiphenyl sulfone (DHDPS) were used. These reactants were initially charged in the kneading reactor and polymerized at a temperature of 300° C. over a period of 3 hours.

The preparation of the salt-containing polymer (SP) for comparative example C3, example 4 and example 5 was effected by a melt polymerization method in a kneading reactor. DCDPS and DHDPS and also potassium carbonate were used. The reactants were introduced continuously into the kneading reactor by means of a powder screw and polymerized at a temperature of 280° C. (C3) or 290° C. (4, 5) over a period of 2.5 hours.

### COMPARATIVE EXAMPLE C1

The salt-containing polymer (SP) prepared as described above was ground to a particle size of about 3 mm without increasing the surface area by the method of the invention. The salt (S) was extracted from the salt-containing polymer (SP) in a fixed bed reactor with water as extractant (E) over a period of 188 h. At regular intervals during the extraction, the proportion of salt (S) in the salt-containing polymer (SP) was determined. The results are listed in table 1.

The flow rate of the water was 500 mL/h. The temperature during the desalination was in the region of 150° C.

### COMPARATIVE EXAMPLE C2

The salt-containing polymer (SP) prepared as described above was ground to a particle size of about 0.5 mm without increasing the surface area by the method of the invention. The salt (S) was extracted from the salt-containing polymer (SP) in a fixed bed reactor with water as extractant (E) over a period of 299 h. At regular intervals during the extraction, the proportion of salt (S) in the salt-containing polymer (SP) was determined. The results are listed in table 2.

The flow rate of the water was 500 mL/h; from 16 h onward, it was increased to 1000 mL/h. The temperature during the desalination was in the region of 150° C.

### COMPARATIVE EXAMPLE C3

The salt-containing polymer (SP) prepared as described above was ground to a particle size of about 2 mm.

Then the ground salt-containing polymer (SP) was treated in a water bath at 95° C. for 24 h. This was followed by the extraction of the salt (S) from the ground salt-containing polymer (SP) in a fixed bed reactor with water as extractant (E) over a period of 72 h. At regular intervals during the extraction, the proportion of salt (S) in the salt-containing polymer (SP) was determined. The results are listed in table 3.

The flow rate of the water in the fixed bed reactor was 1000 mL/h. The temperature during the desalination was in the region of 150° C.

### EXAMPLE 4

The salt-containing polymer (SP) prepared as described above was extruded and drawn to obtain a drawn salt-containing polymer of increased surface area (SPISA). The strand diameter was reduced from 6 mm for the salt-containing polymer (SP) to 1 mm for the salt-containing polymer of increased surface area (SPISA). The salt-containing polymer of increased surface area (SPISA) was subsequently pelletized to a pellet grain length of 2 to 5 mm.

Then the salt-containing polymer of increased surface area (SPISA) was pre-extracted in a water bath at 95° C. for 24 h according to method step b1). This was followed by the extraction of the salt (S) according to method step b2) from the salt-containing polymer of increased surface area (SPISA) in a fixed bed reactor with water as extractant (E) over a period of 72 h. At regular intervals during the extraction, the proportion of salt (S) in the salt-containing polymer (SP) was determined. The results are listed in table 3.

The flow rate of the water in the fixed bed reactor was 1000 mL/h. The temperature during the desalination was in the region of 150° C.

### EXAMPLE 5

Added to the salt-containing polymer (SP) prepared as described above were 5 mol % of N₂ and CO₂, and the salt-containing polymer (SP) was extruded to obtain a foamed salt-containing polymer of increased surface area (SPISA). The salt-containing polymer of increased surface area (SPISA) was subsequently pelletized to a particle size of 2 mm.

Then the salt-containing polymer of increased surface area (SPISA) was pre-extracted in a water bath at 95° C. for 24 h according to method step b1). This was followed by the extraction of the salt (S) according to method step b2) from the salt-containing polymer of increased surface area (SPISA) in a fixed bed reactor with water as extractant (E) over a period of 72 h. At regular intervals during the extraction, the proportion of salt (S) in the salt-containing polymer (SP) was determined. The results are listed in table 3.

The flow rate of the water in the fixed bed reactor was 1000 mL/h. The temperature during the desalination was in the region of 150° C.

TABLE 1

| | C1 |
|---|---|
| Mₙ [g/mol] | 16 800 |
| M_{w} [g/mol] | 52 900 |
| M_{w}/Mₙ | 3.2 |
| Particle size [mm] | ~3 |
| c(t = 1 h) [ppm] | 158 494 |
| c(t = 43 h) [ppm] | 2 617 |
| c(t = 59 h) [ppm] | 1 700 |
| c(t = 131 h) [ppm] | 344 |
| c(t = 149 h) [ppm] | 303 |
| c(t = 170 h) [ppm] | 287 |
| c(t = 188 h) [ppm] | 210 |

TABLE 2

| | C2 |
|---|---|
| Mₙ [g/mol] | 17 700 |
| M_{w} [g/mol] | 51 300 |
| M_{w}/Mₙ | 2.9 |
| Particle size [mm] | ~0.5 |
| c(t = 1 h) [ppm] | 221 552 |
| c(t = 16 h) [ppm] | 1 070 |
| c(t = 41 h) [ppm] | 649 |
| c(t = 65 h) [ppm] | 554 |
| c(t = 83 h) [ppm] | 504 |
| c(t = 101 h [ppm] | 450 |
| c(t = 169 h) [ppm] | 410 |
| c(t = 211 h) [ppm] | 405 |
| c(t = 299 h) [ppm] | 403 |

TABLE 3

| | C3 | 4 | 5 |
|---|---|---|---|
| Mₙ [g/mol] | 21 000 | 20 000 | 20 000 |
| M_{w} [g/mol] | 49 200 | 47 400 | 47 400 |
| M_{w}/Mₙ | 2.34 | 2.37 | 2.37 |
| Particle size | ~2 | ~2 | ~2 |
| [mm] | | | |
| Increase in surface | 0 | 1457 | 948 |
| area [%] | | | |
| VN | 51.7 | 49.4 | 49.4 |
| [mL/g] | | | |
| c(t = 0 h) | 243 000 | 243 000 | 243 000 |
| [ppm] | | | |
| c(t = 24 h) | 46 299 | 23 150 | 11 364 |
| [ppm] | | | |
| c(t = 48 h) | 431 | 168 | 126 |
| [ppm] | | | |
| c(t = 72 h) | 421 | 105 | 63 |
| [ppm] | | | |

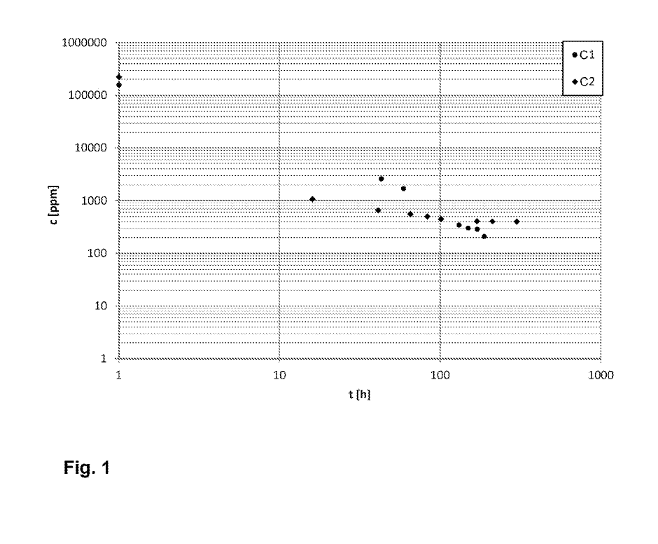

FIG. 1 shows the graph of the proportion of the salt (S), c [ppm], as a function of the duration of desalination, t [h], for comparative experiment C1 (circles) and comparative experiment C2 (rhombuses). It is clearly apparent that the proportion of salt (S) assumes a virtually constant value with time, which is in the region of 200 ppm or in the region of 400 ppm of salt (S) in the desalinated polymer (DP). The inventive proportion of salt (S) in the desalinated polymer (DP) of ≦150 ppm cannot be achieved by simply grinding the salt-containing polymer (SP) and then extracting the salt (S). FIG. 1 also shows that a lower proportion of salt (S) in the polymer is achieved more quickly when the salt-containing polymer (SP) has a greater particle size.

It becomes clear from the examples that it is possible by the method of the invention to obtain a smaller proportion of salt (S) in the desalinated polymer (DP) compared to the desalinated polymers (DP) where the surface area has not been increased mechanically prior to the desalination. Furthermore, the method of the invention gives a much quicker reduction in the proportion of salt (S) in the polymer. Moreover, significantly higher viscosity numbers are obtained for the polymers (DP) desalinated in accordance with the invention.

1. A method for desalinating a salt-containing polymer comprising a polyaryl ether and a salt, the method comprising
a) mechanically increasing a surface area of the salt-containing polymer to obtain a salt-containing polymer of increased surface area, and
b) contacting the salt-containing polymer of increased surface area with an extractant to obtain a desalinated polymer comprising the polyaryl ether, and a salt-containing extractant comprising the extractant and the salt, the surface area of the salt-containing polymer being mechanically increased in a) by foaming or drawing the salt-containing polymer.

2. The method according to claim 1, wherein the salt-containing polymer is prepared by a melt polymerization method.

3. The method according to claim 1, wherein the extractant in b) comprises water.

4. The method according to claim 1, wherein the desalinated polymer obtained in b) comprises not more than 150 ppm by weight of the salt, based on a total weight of the desalinated polymer.

5. The method according to claim 1, wherein b) is conducted at a temperature below a softening temperature of the polyaryl ether.

6. The method according to claim 1, wherein b) comprises:
b1) contacting the salt-containing polymer of increased surface area obtained from a) with the extractant to obtain a pre-desalinated polymer comprising the polyaryl ether and residues of the salt, and a first salt-containing extractant comprising the extractant and a portion of the salt, and
b2) contacting the pre-desalinated polymer obtained from b1) with the extractant to obtain the desalinated polymer comprising the polyaryl ether, and a second salt-containing extractant comprising the extractant and the residues of the salt.

7. The method according to claim 6, wherein b1) is conducted at a temperature of from 50 to 105° C.

8. The method according to claim 6, wherein b2) is conducted at a temperature of higher a 105° C. and lower than a softening temperature of the polyaryl ether.

9. The method according to claim 6, wherein b1) is conducted for a period of from 5 to 50 hours.

10. The method according to claim 6, wherein b2) is conducted for a period of from 10 to 90 hours.

11. The method according to claim 1, wherein the polyaryl ether is a polyaryl ether sulfone.

12. The method according to claim 1, wherein the salt comprises potassium chloride and/or sodium chloride.

13. (canceled)
